(19) United States
(12) Patent Application Publication
(10) Pub. No.: US 2025/0250779 A1
(43) Pub. Date: Aug. 7, 2025

(54) WORKING VEHICLE REMOTE OPERATION ASSISTANCE SYSTEM AND REMOTE CONTROL APPARATUS

(71) Applicant: Kubota Corporation, Osaka (JP)

(72) Inventor: Yoshiki TOKIEDA, Sakai-shi (JP)

(21) Appl. No.: 19/188,363

(22) Filed: Apr. 24, 2025

Related U.S. Application Data
(63) Continuation of application No. PCT/JP2023/047319, filed on Dec. 28, 2023.

(30) Foreign Application Priority Data
Dec. 28, 2022 (JP) 2022-211017

(51) Int. Cl. E02F 9/26; E02F 9/20

(52) U.S. Cl. CPC E02F 9/265; E02F 9/205; E02F 9/261

(57) ABSTRACT

A working vehicle remote operation assistance system includes a detector to detect an attitude of a working vehicle, a first imager to perform imaging of a surrounding area around a working implement coupled to the working vehicle, a second imager to perform imaging of a surrounding area around the working vehicle, different from that of the first imager, and a remote control apparatus including a display to display captured images obtained by the first imager and the second imager and a controller configured to control the display and command that a first attitude object indicating the attitude of the working vehicle detected by the detector be displayed in a superimposed manner on the plurality of captured images displayed on the display.

### CROSS REFERENCE TO RELATED APPLICATIONS

This application is a continuation application of International Application No. PCT/JP2023/047319, filed on Dec. 28, 2023, which claims the benefit of priority to Japanese Patent Application No. 2022-211017, filed on Dec. 28, 2022. The entire contents of each of these applications are hereby incorporated herein by reference.

### BACKGROUND OF THE INVENTION

### 1. Field of the Invention

The present invention relates to working vehicle remote operation assistance systems that each assist remote operation of a working vehicle, and remote control apparatuses.

### 2. Description of the Related Art

For the purpose of assisting remote operation of a working vehicle, for example, Japanese Unexamined Patent Application Publication No. 2020-72401 and Japanese Unexamined Patent Application Publication No. 2001-348914 disclose a technique for displaying a captured image obtained by imaging a front area in front of the working vehicle and an attitude image indicating the attitude of the working vehicle detected by a detector on a remote operation screen. In Japanese Unexamined Patent Application Publication No. 2020-72401, a level image (attitude image) indicating a roll angle and a pitch angle of a working vehicle is displayed in a superimposed manner in a region where the ceiling of the working vehicle visually contained in a captured image is shown. In Japanese Unexamined Patent Application Publication No. 2001-348914, attitude information display images that indicate a front-rear inclination and a left-right inclination with respect to a horizontal state of a working vehicle (heavy machine) respectively are displayed in a superimposed manner at corner portions of a forward captured image.

### SUMMARY OF THE INVENTION

As disclosed in Japanese Unexamined Patent Application Publication Nos. 2020-72401 and 2001-348914, an attitude image that indicates the attitude of a working vehicle is displayed in a superimposed manner on a captured image of one direction only (forward direction) of the working vehicle in a remote operation screen. Therefore, remote control of the working vehicle can be difficult during some operations. For example, especially when an operator who is not experienced causes a working vehicle to travel in the other direction by remote operation or performs work using a working implement that is coupled to the working vehicle at the other-directional end of the working vehicle, the operator is sometimes unable to understand the attitude of the working vehicle even by looking at an attitude image superimposed on a captured image corresponding to one direction and, therefore, it has been difficult to operate the working vehicle remotely.

In light of the above problem, example embodiments of the present invention aim at improving the remote control of a working vehicle by an operator.

Example embodiments of the present invention may include the following features.

A working vehicle remote operation assistance system according to an example embodiment of the present invention includes a detector to detect an attitude of a working vehicle, a first imager to perform imaging of a surrounding area around a working implement coupled to the working vehicle, a second imager to perform imaging of a surrounding area around the working vehicle, different from that of the first imager, and a remote control apparatus including a display to display a plurality of captured images obtained by the first imager and the second imager, and a controller configured or programmed to control the display and command that a first attitude object indicating the attitude of the working vehicle detected by the detector be displayed in a superimposed manner on the plurality of captured images displayed on the display.

The first imager may perform imaging in a direction from the working vehicle to the working implement coupled to the working vehicle, the second imager may perform imaging in a direction toward which the working vehicle travels, and the controller may be configured or programmed to cause the display to display a first captured image obtained by the first imager and a second captured image obtained by the second imager and to superimpose the first attitude object on the displayed first captured image and the displayed second captured image.

The first imager may perform imaging of a rear area behind the working vehicle where there is the working implement coupled thereto, the second imager may perform imaging of a front area in front of the working vehicle, and the controller may be configured or programmed to cause the display to display a rearward captured image of the working vehicle obtained by the first imager and a forward captured image of the working vehicle obtained by the second imager and to superimpose the first attitude object on the displayed rearward captured image and the displayed forward captured image.

The controller may be configured or programmed to command that the first attitude object be displayed in a superimposed manner at center regions of the plurality of captured images.

The controller may be configured or programmed to command that the first attitude object be displayed such that a captured subject visually contained in each of the plurality of captured images at a display position of the first attitude object is viewable.

The controller may be configured or programmed to command that a horizontal reference object corresponding to horizontal attitude of the working vehicle and an index object indicating an angle of inclination of the working vehicle, detected by the detector, be displayed in a superimposed manner, as the first attitude object, on at least any one of the plurality of captured images, and command that the index object be inclined with respect to the horizontal reference object in accordance with the angle of inclination of the working vehicle.

The controller may be configured or programmed to command that a numerical value of the angle of inclination of the working vehicle be displayed in a superimposed manner, as the first attitude object together with the horizontal reference object and the index object, on at least any one of the plurality of captured images.

The controller may be configured or programmed to command that a scale object for reading an angle of inclination of the working vehicle in a predetermined direction and an index object indicating the angle of inclination of the working vehicle in the predetermined direction, detected by the detector, in relation to the scale object be displayed in a superimposed manner, as the first attitude object, on at least any one of the plurality of captured images.

The controller may be configured or programmed to command that the scale object and the index object be inclined in accordance with an angle of inclination of the working vehicle in a direction different from the predetermined direction, detected by the detector.

The controller may be configured or programmed to command that a plurality of scale lines and a plurality of numerical values corresponding to the plurality of scale lines respectively be displayed as the scale object, and command that the plurality of scale lines and the plurality of numerical values be displayed such that a captured subject visually contained in at least any one of the plurality of captured images at a display position of the scale object is viewable.

The controller may be configured or programmed to command that the first attitude object indicating either one or both of a pitch angle and a roll angle of the working vehicle detected by the detector be displayed in a superimposed manner on the plurality of captured images.

The controller may be configured or programmed to command that a second attitude object indicating an attitude of the working implement be displayed in a superimposed manner on, among the plurality of captured images, a captured image visually containing the working implement.

The controller may be configured or programmed to command that the second attitude object indicating the attitude of the working implement after a change, in a case where the attitude of the working implement has been changed by an attitude changer provided on the working vehicle, be displayed in a superimposed manner on the captured image visually containing the working implement.

The controller may be configured or programmed to command that the first attitude object and the second attitude object be displayed in a superimposed manner on a portion of the working vehicle or the working implement visually contained in the plurality of captured images.

A remote control apparatus according to another example embodiment of the present invention is provided in the working vehicle remote operation assistance system including the foregoing configuration.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a diagram illustrating a configuration of a working vehicle remote operation assistance system.

FIG. 2 is a side view of a tractor, which is an example of a working vehicle.

FIG. 3 is a perspective view of a coupling device provided on the working vehicle.

FIG. 4 is a diagram illustrating an example of a state of front-rear inclination of the working vehicle.

FIG. 5 is a diagram illustrating an example of a state of left-right inclination of the working vehicle.

FIG. 6 is a diagram illustrating a state of a left-right change in attitude of a working implement.

FIG. 7 is a flowchart illustrating the operation of the working vehicle and the operation of a remote control apparatus.

FIG. 8 is a diagram illustrating an example of a remote monitoring screen.

FIG. 9 is a flowchart showing a process of displaying a remote monitoring screen.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

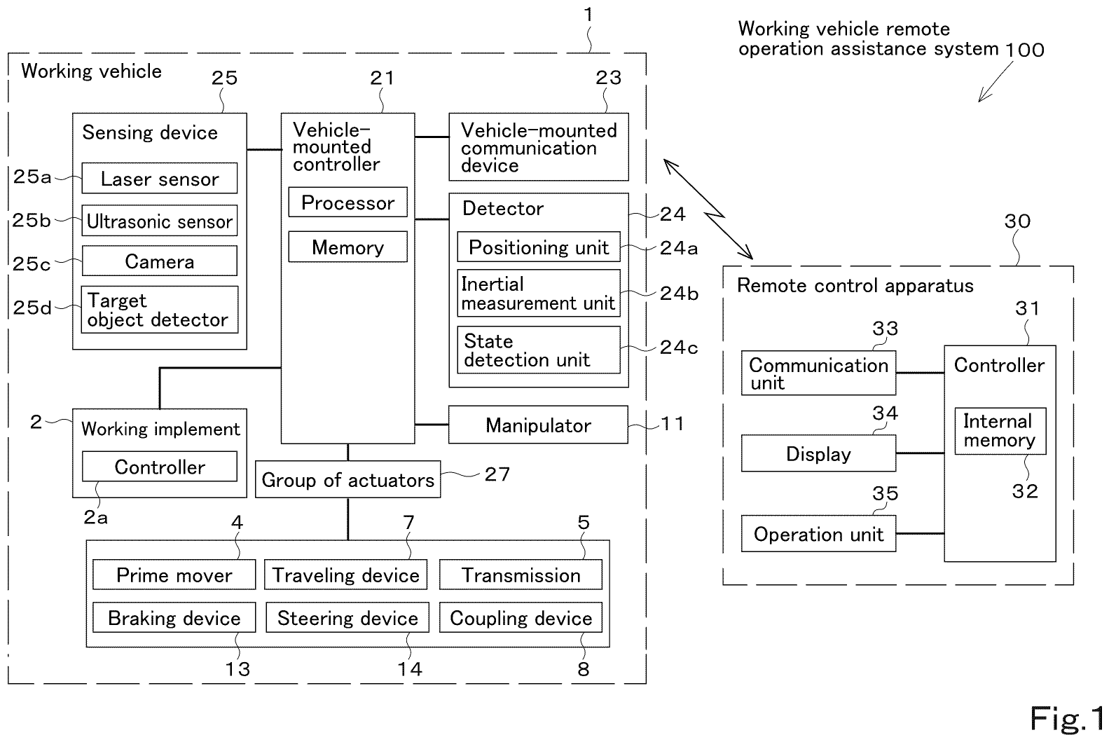

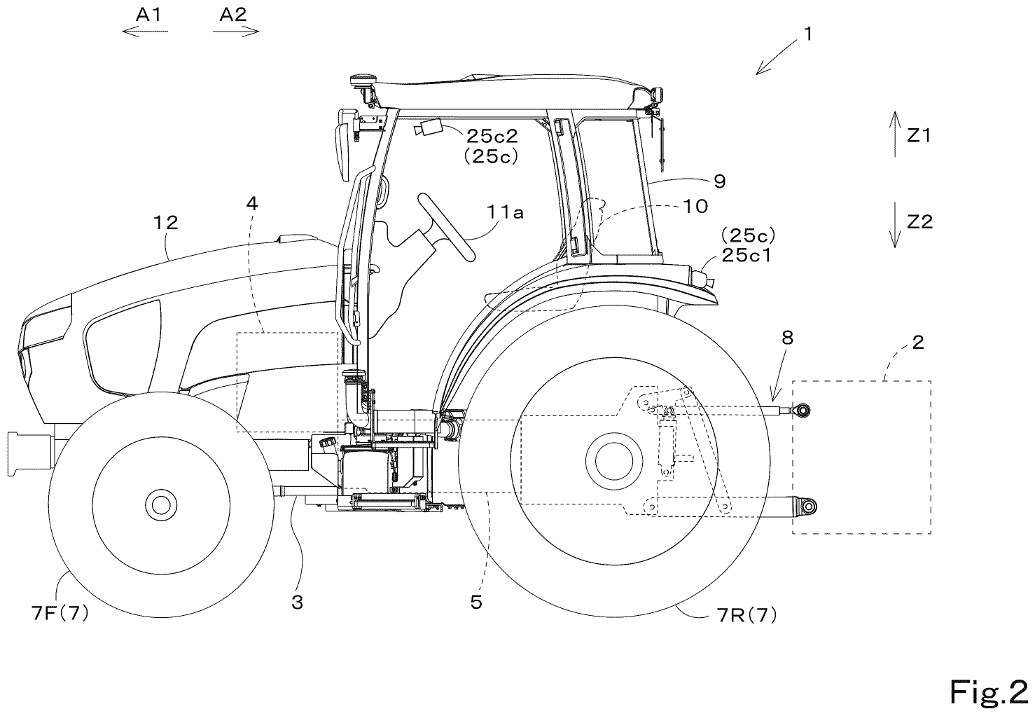

FIG. 1 is a diagram illustrating a configuration of a working vehicle remote operation assistance system 100 according to an example embodiment of the present invention. The remote operation assistance system 100 includes a remote control apparatus 30. The remote operation assistance system 100 and the remote control apparatus 30 assist remote operation of a working vehicle 1. The working vehicle 1 is a farm machine capable of traveling autonomously (referred to also as “autonomous-traveling farm machine”). In the present example embodiment, the working vehicle 1 is a tractor such as one illustrated in FIG. 2. A tractor is an example of a farm machine that performs agricultural work on an agricultural field. The working vehicle 1 may be a farm machine that is not a tractor and is capable of traveling, a construction machine, or the like.

FIG. 2 is a side view of the working vehicle 1 (tractor). The working vehicle 1 includes a vehicle body 3 and a traveling device 7. The traveling device 7 is provided on each of the left side and the right side of the vehicle body 3 and supports the vehicle body 3 to make it travelable. The traveling device 7 is a wheeled-type traveling device that has front wheels 7F and rear wheels 7R that include tires. Instead of this type, a traveling device whose front/rear wheels are of a crawler type may be used.

A prime mover 4, a transmission 5, a braking device 13 (FIG. 1), and a steering device 14 (FIG. 1) are mounted on the vehicle body 3. The prime mover 4 is an engine (a diesel engine, a gasoline engine), an electric motor, or the like. By performing transmission operation, the transmission 5 switches a propelling force of the traveling device 7, and switches the traveling device 7 between forward traveling and rearward traveling. The braking device 13 performs braking on the vehicle body 3. The steering device 14 performs steering of the vehicle body 3.

A cabin 9 is provided on the top of the vehicle body 3. An operator's seat 10 and a manipulator 11 are provided inside the cabin 9. The working vehicle 1 is a tractor capable of performing unmanned traveling (driving) to perform work (agricultural work) via a working implement 2. An operator who is seated on the operator's seat 10 is able to, by manipulating the manipulator 11, cause the working vehicle 1 to perform work via the working implement 2 while traveling. The cabin 9 provides protection to the operator's seat 10 by enclosing the front, the rear, the top, the left side, and the right side of the operator's seat 10.

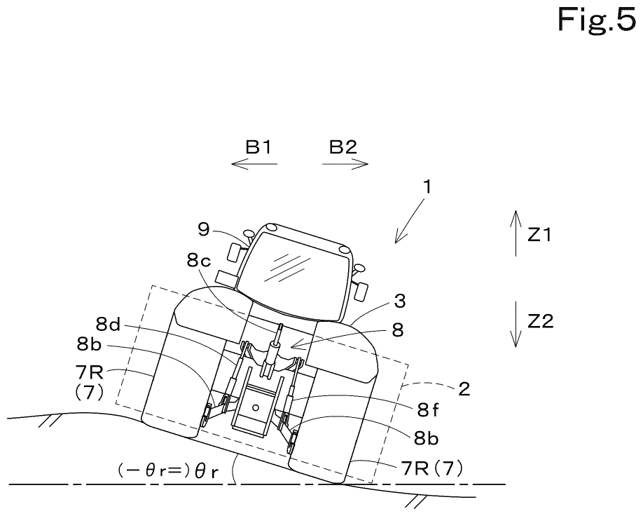

The direction indicated by an arrow A1 in FIG. 2 is a forward direction of the working vehicle 1. The direction indicated by an arrow A2 is a rearward direction of the working vehicle 1. The direction indicated by an arrow Z1 is a top direction of the working vehicle 1. The direction indicated by an arrow Z2 is a bottom direction of the working vehicle 1. The direction orthogonal to the arrows A1, A2, Z1, and Z2 is a width direction (horizontal direction) of the working vehicle 1. The near side in FIG. 2 is the left side with respect to the working vehicle 1 (the direction indicated by B1 in FIG. 5, which will be described later). The far side in FIG. 2 is the right side with respect to the working vehicle 1 (the direction indicated by B2 in FIG. 5).

A coupling device 8, which is used for the coupling of the working implement 2, is provided on a rear portion of the vehicle body 3. That is, the working implement 2 is coupled to the vehicle body 3 of the working vehicle 1 via the coupling device 8. When the traveling device 7 is driven in a state in which the working implement 2 is coupled to the coupling device 8, the working vehicle 1 (the vehicle body 3) travels and tows the working implement 2.

The working implement 2 is, for example, a cultivator for cultivation, a fertilizer spreader for spreading a fertilizer, an agricultural chemical spreader for spreading an agricultural chemical, a harvester for harvesting crops, a mower for cutting grass and the like, a tedder for spreading out grass and the like, a rake for collecting grass and the like, or a baler for baling grass and the like. The working vehicle 1 performs agricultural work on an agricultural field via the working implement 2.

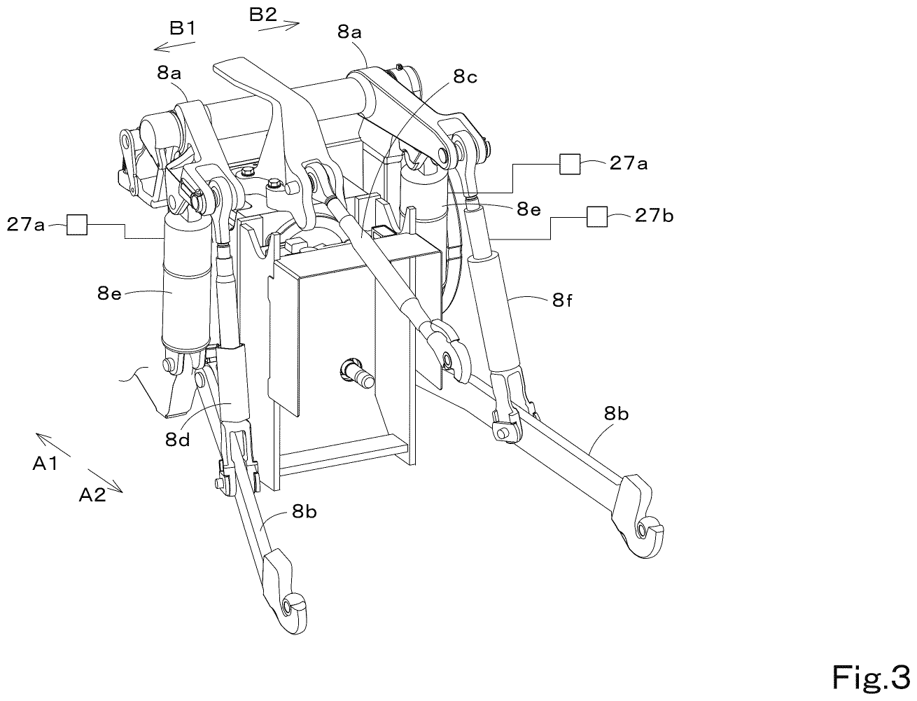

FIG. 3 is a rear perspective view of the coupling device 8. The coupling device 8 is a three-point linkage. More particularly, the coupling device 8 includes lift arms 8a, lower links 8b, a top link 8c, a lift rod 8d, lift cylinders 8e, and an angle change cylinder 8f. Among them, each of the lift arms 8a, the lower links 8b, and the lift cylinders 8e have a left-and-right paired configuration.

The front end portions of the lift arms 8a making up a left-and-right pair are supported in such a way as to be able to move pivotally upward/downward respectively on rear upper portions of a case (transmission case) in which the transmission 5 is housed. The lift arms 8a making up a left-and-right pair move pivotally (are raised and lowered) when driven by the lift cylinders 8e making up a left-and-right pair respectively. Each of the lift cylinders 8e making up a left-and-right pair is a hydraulic cylinder and is connected to a hydraulic pump (not illustrated) of the working vehicle 1 via a control valve 27a. The control valve 27a is a solenoid valve or the like. Each the lift cylinders 8e making up a left-and-right pair extends and retracts in accordance with pressure of a hydraulic fluid supplied via the corresponding one of the control valves 27a.

The front end portions of the lower links 8b making up a left-and-right pair are supported in such a way as to be able to move pivotally upward/downward on rear lower portions of the transmission 5. The front end portion of the top link 8c is supported in such a way as to be able to move pivotally upward/downward behind the transmission 5 above the lower links 8b. The lift rod 8d links the lift arm 8a located on the left side (B1-directional side) to the lower link 8b. The angle change cylinder 8f links the lift arm 8a located on the right side (B2-directional side) to the lower link 8b. The working implement 2 (FIG. 2) is coupled to the rear portions of the lower links 8b making up a left-and-right pair and the rear portion (end portion) of the top link 8c.

The lift arms 8a making up a left-and-right pair rotate up/down due to extension/retraction of the lift cylinders 8e making up a left-and-right pair in the coupling device 8, and the lower links 8b making up a left-and-right pair and each linked to the corresponding lift arm 8a via the lift rod 8d or the angle change cylinder 8f rotate up/down. Then, the working implement 2, which is coupled to the rear portions of the lower links 8b and the rear portion of the top link 8c, moves up/down.

For example, in a case where the working implement 2 is a cultivator, when cultivation work is performed, the working implement 2 is lowered by the coupling device 8 and is located at a work position, at which the working implement 2 is in contact with the ground. The working implement 2 is raised by the coupling device 8 and is located at a non-work position, at which there is a predetermined distance or longer from the ground, when the working vehicle 1 is moving without performing cultivation work. The coupling device 8 is also called a lifting device.

The angle change cylinder 8f of the coupling device 8 is a hydraulic cylinder and is connected to a hydraulic pump via a control valve 27b. The control valve 27b is a solenoid valve or the like. The angle change cylinder 8f extends and retracts in accordance with pressure of a hydraulic fluid supplied via the control valve 27b. The right lower link 8b rotates up/down due to retraction/extension of the angle change cylinder 8f, and the rear portion of the right lower link 8b comes to a position that is above or below the rear portion of the left lower link 8b. Accordingly, the working implement 2, which is coupled to the rear portions of the lower links 8b making up a left-and-right pair and the rear portion of the top link 8c, moves rotationally (becomes tilted) to the left/right around a front-rear axis (a vertical axis that is parallel to the A1 direction and the A2 direction). That is, the inclination attitude (roll angle) of the working implement 2 to the left/right with respect to a horizontal plane is changed by the coupling device 8.

As described above, the coupling device 8 raises and lowers the working implement 2 and causes the working implement 2 to move rotationally to the left/right with respect to the horizontal plane. The coupling device 8 serves also as an attitude changer that changes the attitude of the working implement 2. Depending on the type of the working implement 2, the working implement 2 performs work in a state of being at a distance from the ground. Therefore, some types of the working implement 2 (for example, a spreader) are not raised/lowered by the coupling device 8.

As illustrated in FIG. 2, a hood 12 is provided in front of the cabin 9. The hood 12 is mounted over the vehicle body 3. A housing space (reference numeral omitted) is provided between the hood 12 and the vehicle body 3. Not only the prime mover 4 but also a cooling fan, a radiator, a battery, and the like (not illustrated) are housed in the housing space.

As illustrated in FIG. 1, the working vehicle 1 includes a vehicle-mounted controller 21, a vehicle-mounted communication device 23, a detector 24, a sensing device 25, the manipulator 11, a group of actuators 27, the prime mover 4, the traveling device 7, the transmission 5, the braking device 13, the steering device 14, and the coupling device 8. An in-vehicle network such as CAN, LIN, or FlexRay is built on the working vehicle 1. The vehicle-mounted communication device 23, the detector 24, the sensing device 25, the manipulator 11, the group of actuators 27, the working implement 2 coupled to the working vehicle 1, and the like are electrically connected to the vehicle-mounted controller 21 via the in-vehicle network.

The vehicle-mounted controller 21 is an ECU (Electric Control Unit) that includes a CPU and a memory. The vehicle-mounted controller 21 is a controller configured or programmed to control the operation of each component of the working vehicle 1. The memory of the vehicle-mounted controller 21 is a volatile memory, a non-volatile memory, or the like. Various kinds of information and data to be used by the vehicle-mounted controller 21 to control the operation of each component of the working vehicle 1 are stored in a readable-and-writeable manner in the memory of the vehicle-mounted controller 21.

The vehicle-mounted communication device 23 includes an antenna for wireless communication via a cellular phone communication network or via the Internet or via a wireless LAN, and includes ICs and electric circuits and the like. The vehicle-mounted controller 21 communicates with the remote control apparatus 30 wirelessly via the vehicle-mounted communication device 23.

Although an example in which the working vehicle 1 and the remote control apparatus 30 communicate with each other via a cellular phone communication network, etc., is disclosed in the present example embodiment, instead, for example, the working vehicle 1 and the remote control apparatus 30 may be configured or programmed to be communication-connected to a cellular phone communication network, etc., via an external device such as a server or a relay device. As another example, the working vehicle 1 and the remote control apparatus 30 may be configured or programmed to communicate with each other directly by using a near field communication signal such as a BLE (Bluetooth (Registered trademark) Low Energy) signal or a UHF (Ultra High Frequency) signal. In this case, such communication can be achieved by providing an interface for near field communication in each of the vehicle-mounted communication device 23 and the remote control apparatus 30.

The detector 24 can include a positioning unit 24a and/or an inertial measurement unit (IMU) 24b, and/or a state detection unit 24c. The positioning unit 24a is, for example, provided on the top of the cabin 9 (FIG. 2) (not illustrated in detail). The position where the positioning unit 24a is provided is not limited to the top of the cabin 9. The positioning unit 24a may be provided at any other position over the vehicle body 3 or at a predetermined position on the working implement 2.

The positioning unit 24a measures its own position (measured position information including latitude and longitude) by using for instance a satellite positioning system such as D-GPS, GPS, GLONASS, BeiDou, Galileo, Michibiki, or the like. Specifically, for example, the positioning unit 24a receives signals (positions of positioning satellites, transmission times, correction information, etc.) transmitted from the positioning satellites and detects its own position based on the signals. Then, the positioning unit 24a regards the detected own position as the position of the vehicle body 3. That is, the positioning unit 24a detects the position of the vehicle body 3 (the working vehicle 1). Moreover, the positioning unit 24a calculates the position of the working implement 2 based on the detected own position, pre-stored external-shape information about the working implement 2, and the attachment position of the working implement 2 attached to the vehicle body 3.

The inertial measurement unit 24b can include a gyroscope sensor or an acceleration sensor, etc., and detects a roll angle, a pitch angle, and a yaw angle, etc., of the working vehicle 1 (the vehicle body 3). That is, the inertial measurement unit 24b detects each of the left-right and front-rear inclination attitude of the working vehicle 1 with respect to a horizontal state and the steering state of the working vehicle 1 (its steering angle and steering direction).

The state detection unit 24c detects the state of the working vehicle 1 and the state of the working implement 2. Specifically, various sensors that are provided on components of the working vehicle 1 and the working implement 2, and a computing unit, are included in the state detection unit 24c. The computing unit detects (computes) the operation state of the working vehicle 1 and the operation state of the working implement 2 based on signals outputted from the various sensors. The state of the working vehicle 1 detected by the state detection unit 24c includes the drive/stop state of each component of the working vehicle 1, the traveling direction of the working vehicle 1, the traveling speed thereof, and the like. The state of the working implement 2 detected by the state detection unit 24c includes the drive/stop state of each component of the working implement 2, and the like.

For example, the state detection unit 24c detects the traveling speed of the vehicle body 3 based on an output signal of a number-of-revolutions sensor configured to detect the number of rotations of the front wheels 7F or the rear wheels 7R or detect the number of revolutions of a traveling motor that causes the front/rear wheels 7F/7R to rotate. As another example, the state detection unit 24c may acquire, in a predetermined cycle, the position of the vehicle body 3 detected by the positioning unit 24a, and detect the traveling speed of the vehicle body 3 based on changes (transition) in the position of the vehicle body 3.

The attitude of the working vehicle 1 (the vehicle body 3) is detected by the inertial measurement unit 24b as described above, whereas the attitude of the working implement 2 is detected based on the operating state of the control valves 27a and 27b, the lift cylinders 8e, and the angle change cylinder 8f, the operation of which is controlled by the vehicle-mounted controller 21. Specifically, for example, the vehicle-mounted controller 21 determines the operating position and opening of each of the control valves 27a and 27b based on a control signal inputted into the control valve 27a, 27b, and determines an amount of extension/retraction of each of the lift cylinders 8e and the angle change cylinder 8f based on the determined operating position and opening. Then, the vehicle-mounted controller 21 detects the attitude of the working implement 2 in the vertical direction (the raised/lowered position) and the attitude thereof in the horizontal direction (the angle of inclination to the left/right, that is, the roll angle of the working implement 2) based on the amount of extension/retraction of each of the lift cylinders 8e and the angle change cylinder 8f.

Alternatively, the vehicle-mounted controller 21 may detect the attitude of the working implement 2 in the vertical direction and the attitude thereof in the horizontal direction based on a detection signal outputted from a sensor configured to detect the amount of extension/retraction of each of the lift cylinders 8e and the angle change cylinder 8f. As still another example, the state detection unit 24c may include a sensor configured to detect the attitude of the working implement 2 in the vertical direction and a sensor configured to detect the attitude of the working implement 2 in the horizontal direction.

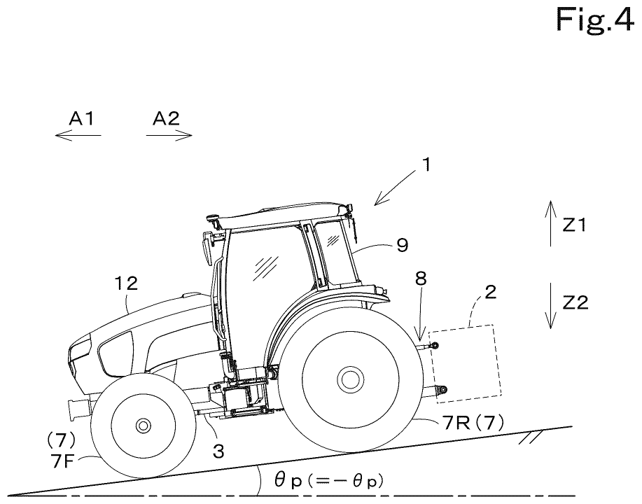

FIG. 4 is a side view of the working vehicle 1 for illustrating an example of a front-rear inclined state of the working vehicle 1. In a case where the vehicle body 3 of the working vehicle 1 is in front-down downhill-inclined attitude as illustrated in FIG. 4, the pitch angle θp of the vehicle body 3 detected by the inertial measurement unit 24b has a negative value (−θp). On the other hand, in a case where the vehicle body 3 of the working vehicle 1 is in rear-down uphill-inclined attitude, the pitch angle θp of the vehicle body 3 detected by the inertial measurement unit 24b has a positive value (+θp) (not illustrated).

FIG. 5 is a rear view of the working vehicle 1 for illustrating an example of a left-right inclined state of the working vehicle 1. In a case where the vehicle body 3 of the working vehicle 1 is in right-down leaning-to-the-right attitude as illustrated in FIG. 5, the roll angle θr of the vehicle body 3 detected by the inertial measurement unit 24b has a negative value (−θr). On the other hand, in a case where the vehicle body 3 of the working vehicle 1 is in left-down leaning-to-the-left attitude, the roll angle θr of the vehicle body 3 detected by the inertial measurement unit 24b has a positive value (+θr) (not illustrated).

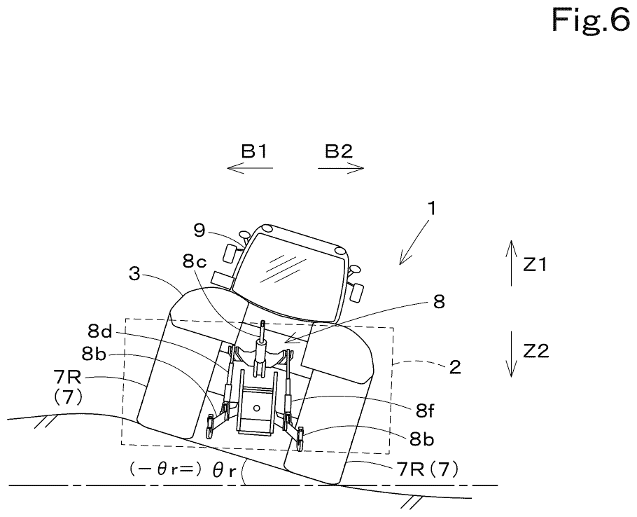

In a case where the vehicle body 3 of the working vehicle 1 is in leaning-to-the-right attitude as illustrated in FIG. 5, the working implement 2 coupled to the vehicle body 3 via the coupling device 8 is also in leaning-to-the-right attitude. In this case, if the working vehicle 1 is set to be in a horizontal work mode (referred to also as “Horizontal Monroe Control Mode”), the vehicle-mounted controller 21 causes the above-mentioned control valve 27b (FIG. 3) to operate to cause retraction of the angle change cylinder 8f of the coupling device 8, thus changing the attitude of the working implement 2 into substantially horizontal attitude as illustrated in FIG. 6. In a case where work is performed by the working implement 2 while the working vehicle 1 is traveling in a state of a change in the attitude of the working implement 2 in this way, the trace of the work will be horizontal with respect to the sloped ground.

In a case where the vehicle body 3 is in leaning-to-the-left attitude, the working implement 2 coupled to the vehicle body 3 via the coupling device 8 is also in leaning-to-the-left attitude. In this case, if the working vehicle 1 is set to be in the horizontal work mode, the vehicle-mounted controller 21 causes the control valve 27b to operate to cause extension of the angle change cylinder 8f of the coupling device 8, thus changing the attitude of the working implement 2 into substantially horizontal attitude.

Besides the horizontal work mode, an inclined-ground work mode (referred to also as “Inclined-ground Monroe Control Mode”) can be set on the working vehicle 1. In a case where the vehicle body 3 of the working vehicle 1 is in leaning-to-the-right attitude or in leaning-to-the-left attitude, if the working vehicle 1 is set to be in the inclined-ground work mode, the vehicle-mounted controller 21 causes the control valve 27b to operate to cause retraction/extension of the angle change cylinder 8f of the coupling device 8, thus changing the attitude of the working implement 2 into attitude of being substantially in parallel with the inclined ground (not illustrated). In a case where work is performed by the working implement 2 while the working vehicle 1 is traveling in a state of a change in the attitude of the working implement 2 in this way, the trace of the work will be level with respect to the sloped ground.

As described above, the detector 24 (the positioning unit 24a, the inertial measurement unit 24b, and the state detection unit 24c) and the vehicle-mounted controller 21 detect the state such as position, operation, attitude, speed, and the like of the working vehicle 1 and the working implement 2. The vehicle-mounted controller 21 generates detection information that indicates the state of the working vehicle 1 and the working implement 2 detected by the detector 24, etc., and outputs the detection information to its own internal memory and the vehicle-mounted communication device 23.

The sensing device 25 performs sensing (monitoring) of an area around the working vehicle 1. More particularly, the sensing device 25 includes laser sensors 25a, ultrasonic sensors 25b, cameras 25c, and a target object detector 25d. Each of the laser sensors 25a and the ultrasonic sensors 25b are provided at appropriate positions, for example, the front portion, the rear portion, the left side portion, and the right side portion, etc., of the working vehicle 1 (not illustrated in detail), and detect surrounding situations in front of, behind, to the left of, and to the right of the working vehicle 1, etc., and detect a target object that is present in the surrounding area. The laser sensors 25a and the ultrasonic sensors 25b provide an example of target object sensors.

The laser sensor 25a is an optical sensor such as a LiDAR (Light Detecting And Ranging) sensor. The ultrasonic sensor 25b is an airborne ultrasound sensor such as a sonar. The target object detector 25d includes an electric circuit or an IC, etc., configured to detect whether a target object is present or absent, the position of the target object, a distance to the target object, and the type of the target object, etc., based on signals outputted from the laser sensors 25a and the ultrasonic sensors 25b. The target object that is detectable by the target object detector 25d includes the site where the working vehicle 1 travels and performs work, an agricultural field, crops on the agricultural field, ground, a road surface, any other object, a person, and the like.

The camera 25c is a CCD camera with a built-in CCD (Charge Coupled Device) image sensor, a CMOS camera with a built-in CMOS (Complementary Metal Oxide Semiconductor) image sensor, or the like. The cameras 25c are installed at appropriate positions respectively, for example, on the front portion, the rear portion, the left side portion, and the right side portion of the working vehicle 1, and inside the cabin 9 thereof, and the like. These cameras 25c perform imaging of a surrounding area in front of, behind, to the left of, and to the right of the working vehicle 1 and the like, and output data of captured images. The camera 25c is an example of an imager.

Among the plurality of cameras 25c provided on the working vehicle 1, a rear camera 25c1 (a first imager), which is installed on the rear portion of the vehicle body 3 of the working vehicle 1 as illustrated in FIG. 2, performs imaging of a surrounding area toward the working implement 2 coupled to the working vehicle 1. That is, the rear camera 25c1 performs imaging in a direction that is toward the working implement 2 coupled to the working vehicle 1, more particularly, toward a rear area behind the working vehicle 1 (the A2 direction, a first direction).

An internal camera 25c2 (a second imager), which is installed inside the cabin 9, performs imaging of a surrounding area around the working vehicle 1 that is different from that of the rear camera 25c1. More particularly, the internal camera 25c2 performs imaging of a front area in front of the working vehicle 1 (the A1 direction, a second direction), namely, in a direction in which the working vehicle 1 travels. Moreover, the internal camera 25c2 performs imaging of a front area in front of the working vehicle 1 with substantially the same field of view as that of the operator who is seated on the operator's seat 10 from the operator's seat 10. The target object detector 25d can also be configured to detect whether a target object is present or absent, the position of the target object, and the type of the target object, etc., based on data of captured images outputted from the plurality of cameras 25c.

The sensing device 25 performs sensing (monitoring) of surrounding situations around the working vehicle 1 and the working implement 2 via the laser sensors 25a, the ultrasonic sensors 25b, the cameras 25c, and the target object detector 25d, and outputs sensing information that indicates the results thereof to the vehicle-mounted controller 21. The sensing information includes at least detection information obtained by the target object detector 25d and data of images captured by the cameras 25c. Besides these kinds of information, detection information obtained by the laser sensors 25a and the ultrasonic sensors 25b may be included in the sensing information.

The detector 24 outputs detection information that indicates the results of detecting the state of the working vehicle 1 and the working implement 2 in a predetermined cycle or at a predetermined timing to the vehicle-mounted controller 21 on a timely basis. The sensing device 25 outputs sensing information that indicates the results of sensing in a predetermined cycle or at a predetermined timing to the vehicle-mounted controller 21 on a timely basis. The vehicle-mounted controller 21 causes its internal memory to store the detection information inputted from the detector 24, the detection information own-detected by the vehicle-mounted controller 21 itself, and the sensing information inputted from the sensing device 25. Moreover, the vehicle-mounted controller 21 transmits the detection information and the sensing information that are stored in the internal memory to the remote control apparatus 30 at a predetermined timing via the vehicle-mounted communication device 23.

Electric-type or hydraulic-type motors, cylinders, and control valves (the afore-mentioned control valves 27a and 27b and the like) to cause the components of the working vehicle 1 such as the prime mover 4, the traveling device 7, the transmission 5, the braking device 13, the coupling device 8, and the like to operate are included in the group of actuators 27. A steering wheel 11a (FIG. 2), an accelerator pedal, a brake pedal, a transmission shift lever, and the like are included in the manipulator 11. The vehicle-mounted controller 21 is configured or programmed to drive the prime mover 4, the traveling device 7, the transmission 5, the braking device 13, and the steering device 14 to control the traveling and steering of the working vehicle 1 by causing a predetermined actuator included in the group of actuators 27 to operate in accordance with a manipulation state of the manipulator 11 and the like.

Moreover, the vehicle-mounted controller 21 communicates with a controller 2a built in the working implement 2 to cause the controller 2a to control the operation of the working implement 2. That is, the vehicle-mounted controller 21 performs work on an agricultural field by indirectly controlling the operation of the working implement 2 via the controller 2a. Some types of the working implement 2 that can be coupled to the working vehicle 1 are not equipped with the controller 2a. In this case, the vehicle-mounted controller 21 causes the working implement 2 to perform work (agricultural work) on an agricultural field by controlling the attitude of the working implement 2 via the coupling device 8.

The vehicle-mounted controller 21 is configured or programmed to control the traveling and steering of the working vehicle 1, the work and attitude of the working implement 2, and other operations of the working vehicle 1 based on the detection information of the detector 24 and the like (inclusive of the detection information of the vehicle-mounted controller 21 itself), the sensing information of the sensing device 25, and the like. In a case where the vehicle-mounted controller 21 receives a remote operation signal transmitted from the remote control apparatus 30 via the vehicle-mounted communication device 23, the vehicle-mounted controller 21 controls the traveling and steering of the working vehicle 1, the work and attitude of the working implement 2, and other operations of the working vehicle 1 based on the remote operation signal in addition to each information mentioned above.

Furthermore, based on the detection information of the target object detector 25d, the vehicle-mounted controller 21 determines whether or not there is a risk of collision of the working vehicle 1 or the working implement 2 with a target object due to approaching within a predetermined distance when controlling the working vehicle 1 and the working implement 2. Then, if it is determined that there is a risk of collision of the working vehicle 1 or the working implement 2 with a target object due to approaching within a predetermined distance, the vehicle-mounted controller 21 is configured or programmed to control the traveling device 7 or the working implement 2, etc., to stop the traveling of the working vehicle 1 and the work that is being performed by the working implement 2, thus avoiding collision with the target object.

The remote control apparatus 30 is a handheld terminal device such as a tablet device or a smartphone, or a computer installed at a base station (not illustrated). In the present example embodiment, the remote control apparatus 30 is a remote operating-and-monitoring device that operates and monitors the working vehicle 1 remotely. That is, the operator operates the working vehicle 1 remotely via the remote control apparatus 30 and monitors a surrounding situation around the working vehicle 1. As another example, the remote control apparatus 30 may be a remote monitoring device that monitors the working vehicle 1 remotely, and a remote operating device that operates the working vehicle 1 remotely may be provided separately in addition to the remote control apparatus 30.

As illustrated in FIG. 1, a controller 31, a communication unit 33, a display 34, and an operation unit 35 are provided in the remote control apparatus 30. The controller 31 includes a CPU and the like. The controller 31 is a processor configured or programmed to control the operation of each component of the remote control apparatus 30. An internal memory 32 provided in the controller 31 is a volatile or non-volatile memory. Various kinds of information and data to be used by the controller 31 to control the operation of each component of the remote control apparatus 30 are stored in a readable-and-writeable manner in the internal memory 32.

The communication unit 33 includes an antenna for wireless communication via a cellular phone communication network or via the Internet or via a wireless LAN, and includes ICs and electric circuits and the like. The controller 31 communicates with the working vehicle 1 wirelessly via the communication unit 33.

The display 34 is, for example, a liquid crystal display or the like. Information for operating the working vehicle 1 remotely is displayed on the display 34. The operation unit 35 is a touch pad, a hardware switch, or the like. By operating the operation unit 35, the operator is able to perform remote operation for the traveling and steering of the working vehicle 1 and the work that is being performed by the working implement 2, and monitor surrounding situations around the working vehicle 1 and the working implement 2 on the display 34. Moreover, the operator is able to input predetermined information or instructions into the remote control apparatus 30 by operating the operation unit 35.

The operation unit 35 is an example of an input device. The display 34 and the operation unit 35 provide an example of a user interface. As another example, in place of the display 34 and the operation unit 35, an integrated user interface such as a touch panel that is a combination of a display and an operation unit may be provided in the remote control apparatus 30.

When the operator operates the operation unit 35 to input operation instructions for operating the working vehicle 1, the controller 31 generates a remote operation signal corresponding to the operation instructions and transmits the remote operation signal to the working vehicle 1 via the communication unit 33. Upon receiving the remote operation signal from the remote control apparatus 30 via the vehicle-mounted communication device 23, the vehicle-mounted controller 21 of the working vehicle 1 controls the traveling and steering of the working vehicle 1 and the work operation of the working implement 2 by causing each component of the working vehicle 1 to operate based on the remote operation signal, the detection information of the detector 24 and the like, and the sensing information of the sensing device 25. Moreover, the vehicle-mounted controller 21 transmits the detection information and the sensing information to the remote control apparatus 30 via the vehicle-mounted communication device 23.

Upon receiving the detection information and the sensing information via the communication unit 33, the controller 31 of the remote control apparatus 30 causes the internal memory 32 to store these kinds of information and causes the display 34 to display them. In particular, the controller 31 causes the display 34 to display a remote monitoring screen that includes a forward captured image and a rearward captured image, which are obtained by imaging a front area in front of the working vehicle 1 and a rear area behind the working vehicle 1 via the cameras 25c. The controller 31 causes the display 34 to perform superimposed display of objects that indicate the attitude of the working vehicle 1 or the working implement 2 on each of the captured images, in the present case on each of the forward captured image and the rearward captured image that are displayed on the display 34. It follows that the forward captured image on which the object indicating the attitude of the working vehicle 1 is displayed in a superimposed manner and the rearward captured image on which the object indicating the attitude of the working implement 2 is displayed in a superimposed manner are displayed together on the remote monitoring screen.

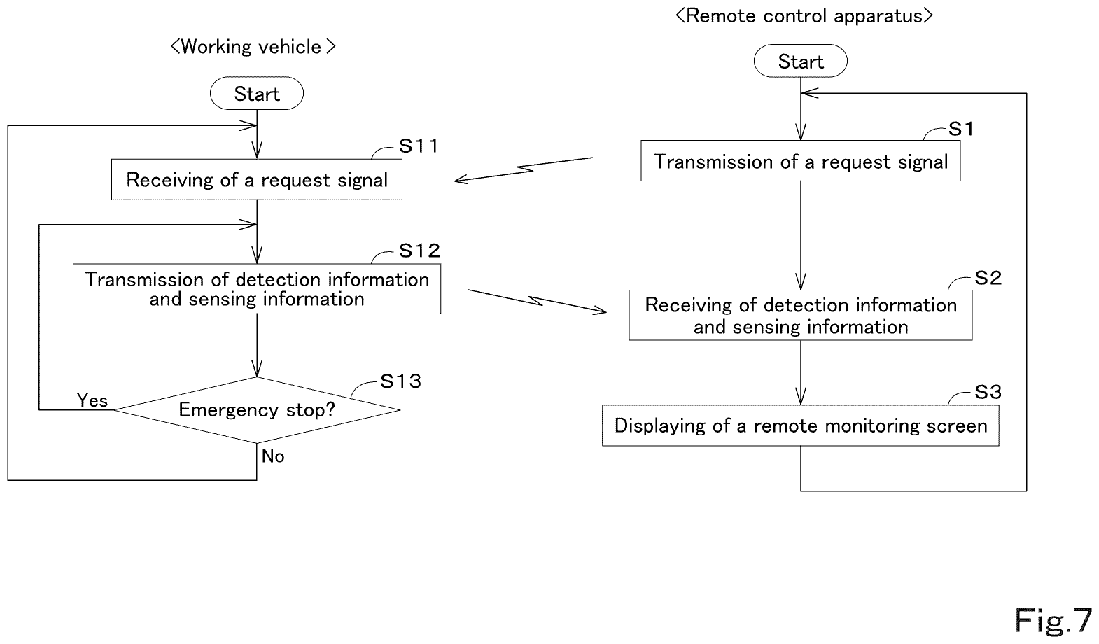

FIG. 7 is a flowchart illustrating the operation of the working vehicle 1 and the operation of the remote control apparatus 30. Each step in the left half of the flowchart of FIG. 7 is executed by the vehicle-mounted controller 21 of the working vehicle 1 based on a software program stored in its internal memory. Each step in the right half of the flowchart of FIG. 7 is executed by the controller 31 of the remote control apparatus 30 based on a software program stored in the internal memory 32.

Upon activation of the remote control apparatus 30, the controller 31 transmits a request signal for information detected by the working vehicle 1 to the working vehicle 1 via the communication unit 33 (S1). Upon receiving the request signal from the remote control apparatus 30 via the vehicle-mounted communication device 23 (S11), the vehicle-mounted controller 21 of the working vehicle 1 transmits the detection information of the detector 24, etc., and the sensing information of the sensing device 25 to the remote control apparatus 30 via the vehicle-mounted communication device 23 (S12).

Upon receiving the detection information and the sensing information via the communication unit 33 (S2), the controller 31 of the remote control apparatus 30 causes the internal memory 32 to store these kinds of information first and thereafter reads them out. Then, the controller 31 causes the display 34 to display a remote monitoring screen based on the read detection information and the read sensing information (S3). A detailed explanation of the remote monitoring screen will be given later.

Upon a lapse of predetermined time after the remote monitoring screen was displayed, the controller 31 transmits a request signal again to the working vehicle 1 (S1). Upon receiving the request signal from the remote control apparatus 30 again (S11), the vehicle-mounted controller 21 transmits the detection information of the detector 24, etc., and the sensing information of the sensing device 25 to the remote control apparatus 30 again (S12). Upon receiving the detection information and the sensing information again (S2), the controller 31 instructs for remote monitoring screen display again based on the received information (S3).

As described above, the detection information of the detector 24, etc., and the sensing information of the sensing device 25 of the working vehicle 1 are transmitted from the working vehicle 1 to the remote control apparatus 30 cyclically, and the remote monitoring screen is updated cyclically based on the detection information and the sensing information.

When the operator inputs operation instructions for the traveling of the working vehicle 1 and the like by operating the operation unit 35 of the remote control apparatus 30, the controller 31 transmits a remote operation signal corresponding to the operation instructions to the working vehicle 1 via the communication unit 33, and, in addition, transmits a request signal to the working vehicle 1 (S1). Also in this case, upon receiving the request signal from the remote control apparatus 30 again (S11), the vehicle-mounted controller 21 transmits the detection information of the detector 24, etc., and the sensing information of the sensing device 25 to the remote control apparatus 30 again (S12). Upon receiving the detection information and the sensing information again (S2), the controller 31 instructs for remote monitoring screen display again based on the received information (S3).

As described above, each time the operator inputs operation instructions for operating the working vehicle 1 into the remote control apparatus 30, the detection information of the detector 24, etc., and the sensing information of the sensing device 25 are transmitted from the working vehicle 1 to the remote control apparatus 30, and the remote monitoring screen is updated based on the detection information and the sensing information.

When the working vehicle 1 is traveling under remote operation by the remote control apparatus 30, the vehicle-mounted controller 21 sometimes issues a command for an emergency stop of the traveling of the working vehicle 1 automatically based on the sensing information of the sensing device 25 in order to prevent a collision of the working vehicle 1 with an obstacle (S13: YES). In this case, the vehicle-mounted controller 21 transmits the detection information of the detector 24, etc., and the sensing information of the sensing device 25 to the remote control apparatus 30 via the vehicle-mounted communication device 23 (S12). Upon receiving the detection information and the sensing information (S2), the controller 31 provides an instruction to perform remote monitoring screen display based on the received information (S3).

That is, also in a case of an automatic emergency stop of the working vehicle 1 during traveling of the working vehicle 1 under remote operation, the detection information of the detector 24, etc., and the sensing information of the sensing device 25 are transmitted from the working vehicle 1 to the remote control apparatus 30, and the remote monitoring screen is updated based on the detection information and the sensing information. The operation of the remote control apparatus 30 and the working vehicle 1 illustrated in FIG. 7, and the display of the remote monitoring screen, are repeated continuously until the remote control apparatus 30 stops (power OFF).

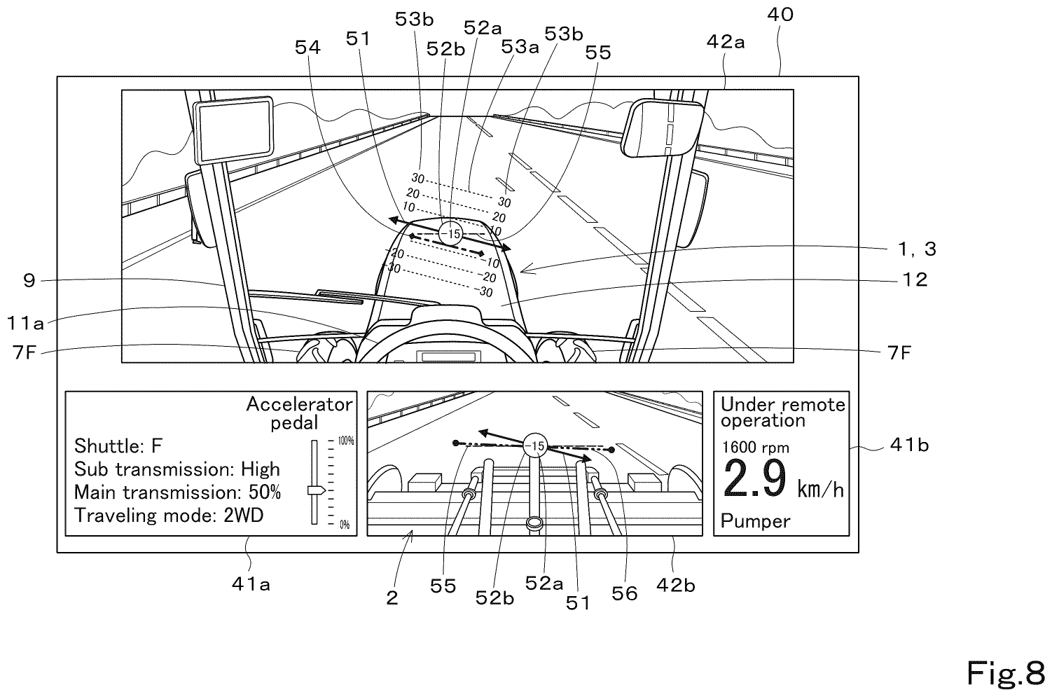

FIG. 8 is a diagram illustrating an example of a remote monitoring screen 40 displayed on the display 34. More particularly, FIG. 8 illustrates a remote monitoring screen 40 displayed on the display 34 during traveling of the working vehicle 1 under remote operation.

The controller 31 of the remote control apparatus 30 commands that the state of the working vehicle 1 detected by the detector 24 and the vehicle-mounted controller 21 of the working vehicle 1 should be displayed in windows 41a and 41b of the remote monitoring screen 40. In the example illustrated in FIG. 8, it is displayed in the window 41a as follows: the traveling direction of the traveling device 7 is a forward direction (“Shuttle: F”); the sub transmission of the transmission 5 is high-speed, (“Sub transmission: High”); the state of the main transmission (continuously variable transmission) is 50% (“Main transmission: 50%”); the working vehicle 1 is traveling in a two-wheel-drive mode (“Traveling mode: 2WD”); and the operation amount of the accelerator pedal is 40%. It is displayed in the window 41b as follows: the working vehicle 1 is traveling under remote operation (“Under remote operation”); the traveling speed of the working vehicle 1 (the vehicle body 3) is 2.9 km/h; and the number of revolutions of the prime mover 4 is 1,600 rpm.

The information displayed in the window 41a, 41b is not limited to the state of the working vehicle 1 described above. The number of the windows 41a and 41b is not limited to two. The screen may have a single window only, or three or more windows. The controller 31 may command that not only the state of the working vehicle 1 but also whether the working implement 2 is coupled to the working vehicle 1 or not, the type of the working implement 2, and the like should be displayed in a window(s) of the remote monitoring screen 40 based on the detection information of the detector 24, etc., and the sensing information of the sensing device 25.

In addition, the controller 31 causes the display 34 to display, on the remote monitoring screen 40, at least two captured images obtained by imaging two distinct portions of the vehicle in different areas of the display 34. In the illustrated example embodiment, the controller 31 causes the display 34 to display, on the remote monitoring screen 40, a forward captured image 42a obtained by imaging a front area in front of the working vehicle 1 along the virtual line of sight of the operator via the internal camera 25c2 (FIG. 2) installed inside the cabin 9 and a rearward captured image 42b obtained by imaging a rear area behind the working vehicle 1 via the rear camera 25c1 (FIG. 2) installed on the rear portion of the vehicle body 3 among the plurality of cameras 25c provided on the working vehicle 1. That is, the forward captured image and the rearward captured image are displayed together on the remote monitoring screen 40.

The forward captured image 42a visually contains a portion of those provided inside the cabin 9 (pillars, mirrors, the steering wheel 11a, and the like), the front portion of the working vehicle 1 (the hood 12, the front wheels 7F, and the like), and captured ambient surroundings in front of the working vehicle 1. The rearward captured image 42b visually contains a portion of the coupling device 8 provided on the rear portion of the vehicle body 3, a portion of the working implement 2 coupled to the coupling device 8, and captured ambient surroundings behind the working vehicle 1.

A rear internal camera configured to perform imaging of a rear area behind the working vehicle 1 along the virtual line of sight of the operator may be installed inside the cabin 9, instead of providing the internal camera 25c2 alone inside the cabin 9. Then, the controller 31 may cause the display 34 to display, on the remote monitoring screen 40, a rearward captured image obtained via the rear internal camera in place of, or in addition to, the rearward captured image 42b. In addition, the controller 31 may cause the display 34 to display, on the remote monitoring screen 40, a forward captured image obtained by imaging a front area in front of the working vehicle 1 via another camera 25c (not illustrated), which is installed on the front portion of the vehicle body 3, in place of, or in addition to, the forward captured image 42a.

In the example illustrated in FIG. 8, the forward captured image 42a is displayed to be larger than the rearward captured image 42b. Instead of this example, the controller 31 may command that, for example, the forward captured image 42a should be displayed to be larger than the rearward captured image 42b when the working vehicle 1 (the vehicle body 3) is traveling forward, and the rearward captured image 42b should be displayed to be larger than the forward captured image 42a when the working vehicle 1 is traveling rearward.

As illustrated in FIG. 8, the controller 31 causes the display 34 to perform superimposed display of vehicle attitude objects (first attitude objects) 51 to 55, which indicate the attitude of the working vehicle 1 (the vehicle body 3) detected by the inertial measurement unit 24b of the detector 24, on each of the forward captured image 42a and the rearward captured image 42b that are included in the remote monitoring screen 40. That is, the forward captured image 42a on which the attitude objects 51, 52a, 52b, 53a, 53b, 54, and 55 are displayed in a superimposed manner and a rearward captured image 42b on which the attitude objects 51, 52a, 52b, and 55 are displayed in a superimposed manner are displayed together on the remote monitoring screen 40.

The vehicle attitude objects 51 to 55 can for instance include a horizontal reference line (horizontal reference object) 55, which corresponds to the horizontal attitude of the working vehicle 1, a roll index line (first index object) 51, which indicates the roll angle θr of the working vehicle 1 (angle of inclination to the left/right), a numerical value 52a of the roll angle θr of the working vehicle 1, and a display area 52b of the numerical value 52a. The controller 31 commands that, in accordance with the roll angle θr of the working vehicle 1 detected by the inertial measurement unit 24b, the roll index line 51 should be superimposed in an inclined manner with respect to the horizontal reference line 55, which is also superimposed, on each of the forward captured image 42a and the rearward captured image 42b. Moreover, the controller 31 commands that the display area 52b having a shape of a circle should be displayed in a superimposed manner at the center of the roll index line 51, and the numerical value 52a of the roll angle θr should be displayed in a superimposed manner inside the display area 52b.

In the illustrated example embodiment, the vehicle attitude objects 51 to 55 further include a plurality of scale lines (scale object) 53a making up a scale to be used for reading the pitch angle θp of the working vehicle 1 (angle of forward/rearward inclination, second angle of inclination), numerical values 53b corresponding to the scale lines 53a, respectively, and a pitch index line (second index object) 54 that indicates the pitch angle θp of the working vehicle 1 on the scale made up of the plurality of scale lines 53a. The controller 31 commands that the plurality of scale lines 53a and the numerical values 53b should be displayed in a superimposed manner on the forward captured image 42a.

Moreover, in accordance with the pitch angle θp of the working vehicle 1 detected by the inertial measurement unit 24b, the controller 31 commands that the pitch index line 54 should be displayed in a superimposed manner either on any one of the plurality of scale lines 53a included in the forward captured image 42a or between any two scale lines 53a located next to each other. Furthermore, the controller 31 commands that the plurality of scale lines 53a, the numerical values 53b, and the pitch index line 54 should be inclined to the left/right in accordance with the roll angle θr of the working vehicle 1 (first angle of inclination).

In the example illustrated in FIG. 8, a case where the controller 31 commands the display of the vehicle attitude objects 51 to 55 when the working vehicle 1 is in leaning-to-the-right attitude (FIG. 5) and in downhill-inclined attitude (FIG. 4) is shown. Thus, the roll angle θr indicated by the roll index line 51 and by the numerical value 52a has a negative value (−θr [−15°]), and the pitch angle θp indicated by the pitch index line 54 and by the numerical value 53b also has a negative value (−θp [−7°]). Furthermore, since the roll angle of the working vehicle 1 has a negative value (−θr), the plurality of scale lines 53a, the numerical values 53b, and the pitch index line 54 are sloped down to the right in accordance with the roll angle (−θr).

In a case where the working vehicle 1 is in leaning-to-the-left attitude, the roll angle θr commanded by the controller 31 to be indicated by the roll index line 51 and by the numerical value 52a has a positive value (+θr). Accordingly, the plurality of scale lines 53a, the numerical values 53b, and the pitch index line 54 are sloped down to the left in accordance with the roll angle (+θr) (not illustrated). In a case where the working vehicle 1 is in uphill-inclined attitude, the pitch angle θp commanded by the controller 31 to be indicated by the pitch index line 54 and by the numerical value 53b has a positive value (+θp) (not illustrated).

In addition, the controller 31 causes the display 34 to display a work attitude line (second attitude object) 56, which indicates the attitude of the working implement 2 detected by the vehicle-mounted controller 21, in a superimposed manner on the rearward captured image 42b included in the remote monitoring screen 40. More particularly, in a case where the attitude of the working implement 2 with respect to the horizontal direction (leaning-to-the-right attitude illustrated in FIG. 5, or non-illustrated leaning-to-the-left attitude) is changed by the angle change cylinder 8f of the coupling device 8 of the working vehicle 1 or the like, the vehicle-mounted controller 21 detects the attitude of the working implement 2 with respect to the horizontal direction after the change, that is, the roll angle of the working implement 2 after the change. Then, the controller 31 commands that each of the work attitude line 56 and the horizontal reference line 55 should be displayed in a superimposed manner on the rearward captured image 42b, with the work attitude line 56 inclined with respect to the horizontal reference line 55 in accordance with the roll angle of the working implement 2 after the change.

As illustrated in FIG. 8, the controller 31 commands superimposed display of the roll index line 51, the numerical value 52a, the display area 52b, the scale lines 53a, the numerical values 53b, the pitch index line 54, and the horizontal reference line 55 at a center region of the forward captured image 42a. Moreover, the controller 31 commands superimposed display of the roll index line 51, the numerical value 52a, the display area 52b, and the work attitude line 56 at a center region of the rearward captured image 42b.

Furthermore, the controller 31 commands that the vehicle attitude objects 51 to 55 should be displayed such that a captured subject visually contained in the forward captured image 42a at display positions of the vehicle attitude objects 51 to 55 is viewable. Specifically, the controller 31 commands that each of the plurality of vehicle attitude objects 51 to 55 should be displayed on the forward captured image 42a, instead of displaying an image having an area size including the plurality of vehicle attitude objects 51 to 55 on the forward captured image 42a.

In addition, the controller 31 configures each of the roll index line 51, the scale line 53a, the pitch index line 54, and the horizontal reference line 55 in the form of a one-dimensional line-segment object not having an area size, and commands that they should be displayed as such objects on the forward captured image 42a. Moreover, the controller 31 configures each of the numerical values 52a and 53b in the form of a character object, and commands that they should be displayed as such objects on the forward captured image 42a. Furthermore, the controller 31 configures the display area 52b in the form of a small-diameter circle object capable of surrounding the numerical value 52a, and commands that it should be displayed as such an object on the forward captured image 42a. Furthermore, the controller 31 sets the position, pitch, and size of each of the vehicle attitude objects 51 to 55 such that the captured subject visually contained at display positions of the vehicle attitude objects 51 to 55 in the forward captured image 42a will not be covered entirely, and commands that the vehicle attitude objects 51 to 55 should be displayed on the forward captured image 42a in accordance with the content of this setting.

Furthermore, the controller 31 commands that the vehicle attitude objects 51, 52a, 52b, and 55 and the work attitude line 56 should be displayed such that a captured subject visually contained in the rearward captured image 42b at display positions of these attitude objects 51, 52a, 52b, 55, and 56 is viewable. Specifically, the controller 31 commands that each of the plurality of attitude objects 51, 52a, 52b, 55, and 56 should be displayed on the rearward captured image 42b, instead of displaying an image having an area size including the plurality of attitude objects 51, 52a, 52b, 55, and 56 on the rearward captured image 42b.

In addition, the controller 31 configures the work attitude line 56 in the form of a one-dimensional line-segment object not having an area size, similarly to the roll index line 51 and the horizontal reference line 55, and commands that they should be displayed as such objects on the rearward captured image 42b. Moreover, the controller 31 configures the numerical value 52a in the form of a character object, configures the display area 52b in the form of a small-diameter circle object, and commands that they should be displayed as such objects on the rearward captured image 42b. Furthermore, the controller 31 sets the position, pitch, and size of each of the attitude objects 51, 52a, 52b, 55, and 56 such that the captured subject visually contained at display positions of the attitude objects 51, 52a, 52b, 55, and 56 in the rearward captured image 42b will not be covered entirely, and commands that the attitude objects 51, 52a, 52b, 55, and 56 should be displayed on the rearward captured image 42b in accordance with the content of this setting.

In addition, the controller 31 commands that the vehicle attitude objects 51 to 55 should be displayed in a superimposed manner on a portion (in the example illustrated in FIG. 8, the hood 12) of the working vehicle 1 visually contained in the forward captured image 42a. Moreover, the controller 31 commands that the vehicle attitude objects 51, 52a, 52b, and 55 or the work attitude line 56 should be displayed in a superimposed manner on a portion (in the example illustrated in FIG. 8, the coupling device 8) of the working vehicle 1 visually contained in the rearward captured image 42b. Alternatively, depending on the type or size of the working implement 2, the controller 31 commands that the vehicle attitude objects 51, 52a, 52b, and 55 or the work attitude line 56 should be displayed in a superimposed manner on a portion of the working implement 2 visually contained in the rearward captured image 42b (not illustrated).

In addition, the controller 31 commands that, on the forward captured image 42a and the rearward captured image 42b, the roll index line 51 indicating the roll angle θr of the working vehicle 1, the pitch index line 54 indicating the pitch angle θp of the working vehicle 1, the horizontal reference line 55, and the work attitude line 56 such that they will look different from one another in terms of line type, shape (thickness, length, end shape), color, brightness, lightness, saturation, or the like. In the example illustrated in FIG. 8, the controller 31 commands that the roll index line 51, the pitch index line 54, the horizontal reference line 55, and the work attitude line 56 should be different from one another in terms of line type, length, end shape (arrowhead, rhombus, circle, presence/absence thereof). Instead of this, the controller 31 may command that these lines should be displayed using different display colors, for example, the roll index line 51 in purple, the pitch index line 54 in blue, the horizontal reference line 55 in red, and the work attitude line 56 in green.

In the example illustrated in FIG. 8, the controller 31 commands that the scale lines 53a should be displayed using a line type that is different from that of the pitch index line 54. Instead of this, for example, the same color may be used for displaying the scale lines 53a and the pitch index line 54 so as to clearly associate the scale lines 53a and the pitch index line 54 with each other. Moreover, the numerical values 53b may also be displayed using the same color as that of the scale lines 53a and the pitch index line 54 so as to clearly associate them with one another.

In addition, for example, the controller 31 may command that the inside of the display area 52b should be transparent so that a captured subject (in the example illustrated in FIG. 8, a road) visually contained therein on the background can be viewed. Alternatively, the inside of the display area 52b may be semitransparent or opaque. Moreover, for example, the controller 31 may configure the display area 52b in the form of a rectangular object. Alternatively, the display area 52b may be omitted, and the numerical value 52a may be displayed on the roll index line 51 or near the roll index line 51.

Though the numerical value 52a of the roll angle θr is not inclined in the example illustrated in FIG. 8, the controller 31 may command that the numerical value 52a, with an inclination with respect to the horizontal reference line 55 in accordance with the roll angle θr, should be displayed in a superimposed manner on each of the forward captured image 42a and the rearward captured image 42b.

Though a numerical value of the pitch angle θp is not displayed in the example illustrated in FIG. 8, the controller 31 may command that a numerical value of the pitch angle θp should be displayed on the pitch index line 54 or near the pitch index line 54 or the like correspondingly to the pitch index line 54. The controller 31 may command that a numerical value of the roll angle of the working implement 2 after the change should also be displayed on the work attitude line 56 or near the work attitude line 56 or the like correspondingly to the work attitude line 56.

Though the roll index line 51, the numerical value 52a, the display area 52b, the horizontal reference line 55, and the work attitude line 56 are displayed in a superimposed manner on the rearward captured image 42b in the example illustrated in FIG. 8, the controller 31 may command that the scale lines 53a, the numerical values 53b, and the pitch index line 54 should be displayed in a superimposed manner on the rearward captured image 42b in addition to, or in place of, the roll index line 51 and the like.

A predetermined setting screen may be displayed on the display 34 in response to the operator operating the operation unit 35 of the remote control apparatus 30, and, on the setting screen, the operator may be able to select which of the attitude objects 51 to 56 should be displayed in a superimposed manner on the forward captured image 42a or the rearward captured image 42b. The setting screen mentioned above may be configured such that the operator is able to select whether or not to display a vehicle attitude object(s) that indicates the attitude of the working vehicle 1 other than the attitude objects 51 to 56 and a work attitude object that indicates the attitude of the working implement 2.

The operator may select, on a predetermined setting screen, any one or more of a plurality of captured images obtained by imaging a front area in front of, a rear area behind, a left side area to the left of, and a right side area to the right of the working vehicle 1 via the plurality of cameras 25c, and the controller 31 may command that the selected captured image(s) should be displayed on the remote monitoring screen 40 and that the vehicle attitude objects 51 to 55 and the work attitude object 56 should be displayed on the displayed captured image(s).

In a case where the working implement 2 is coupled at any direction that is not behind the working vehicle 1, among a plurality of captured images obtained by imaging a front area in front of, a rear area behind, a left side area to the left of, and a right side area to the right of the working vehicle 1 via the plurality of cameras 25c, a captured image corresponding to the direction at which the working implement 2 is coupled and a captured image corresponding to the direction in which the working vehicle 1 travels may be displayed on the remote monitoring screen 40 by the display 34, and the vehicle attitude objects 51 to 55 and the work attitude object 56 may be displayed on the displayed captured images.

The manner as to how the vehicle attitude objects 51 to 55 and the work attitude object 56 are displayed, for example, line type, shape, color, brightness, lightness, saturation, or a degree of transparency, etc., thereof, may be settable by the operator on a predetermined setting screen.

Though the plurality of scale lines 53a and the plurality of numerical values 53b thereof are displayed on the forward captured image 42a in order to make the pitch angle θp of the vehicle body 3 readable in the example illustrated in FIG. 8, the controller 31 may command that a plurality of scale lines making up a scale to be used for reading the roll angle θr of the vehicle body 3 and a plurality of numerical values corresponding to these scale lines should be displayed, together with the roll index line 51, in a superimposed manner at predetermined angular intervals on the forward captured image 42a and the rearward captured image 42b. In this case, the controller 31 may command that the numerical value 52a of the roll angle θr and the display area 52b should be omitted. Moreover, the controller 31 may command that a plurality of scale lines making up a scale to be used for reading the roll angle of the working implement 2 and a plurality of numerical values corresponding to these scale lines should be displayed, together with the work attitude line 56, in a superimposed manner at predetermined angular intervals on the rearward captured image 42b.

In the example illustrated in FIG. 8, the attitude (roll angle) of the working implement 2 with respect to the horizontal direction after the change by the angle change cylinder 8f, etc., is displayed in a superimposed manner on the rearward captured image 42b. However, for example, before the attitude of the working implement 2 with respect to the horizontal direction is changed by the coupling device 8, the controller 31 may skip displaying the attitude of the working implement 2 with respect to the horizontal direction on the rearward captured image 42b or, alternatively, may command that the current attitude of the working implement 2 with respect to the horizontal direction (the attitude before the change) should be displayed on the rearward captured image 42b.

The controller 31 may command that a work attitude object that indicates the attitude of the working implement 2 with respect to the vertical direction (raised/lowered position (work position, non-work position, etc.)) should be displayed on the rearward captured image 42b or may command that an object that indicates the attitude of the working implement 2 with respect to the vertical direction should be displayed on the remote monitoring screen 40.

In a case where the working implement 2 is a working implement any attitude of which is adjustable among attitude around an axis parallel to the horizontal direction (tilt), attitude around an axis parallel to the vertical direction (angle), attitude of being offset in the horizontal direction, and the like, each said attitude of the working implement 2 may be detected by the vehicle-mounted controller 21 or the detector 24, and the controller 31 of the remote control apparatus 30 may command that a work attitude object that indicates the detected attitude of the working implement 2 should be displayed in a superimposed manner on the rearward captured image 42b, etc., included in the remote monitoring screen 40.

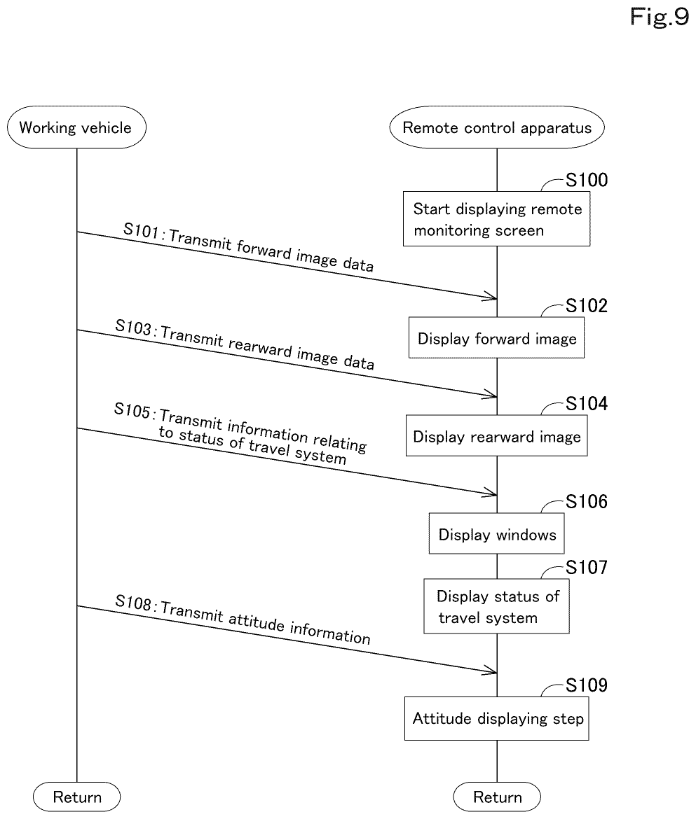

FIG. 9 is a flowchart showing a process of displaying a remote monitoring screen 40 shown in FIG. 8. As shown in FIG. 9, upon starting the remote control apparatus 30, the controller 31 of the remote control apparatus 30 starts a step of causing the display 34 to display a remote monitoring screen 40 (S100).

The vehicle-mounted controller 21 of the working vehicle 1 causes the vehicle-mounted communication device 23 to transmit forward image data, which is data of a forward captured image (forward image) 42a captured by the internal camera 25c2, from the working vehicle 1 to the remote control apparatus 30 (S101). Upon receipt of the forward image data by the communication unit 33 of the remote control apparatus 30, the controller 31 causes the display 34 to display, on the remote monitoring screen 40, the forward captured image 42a based on the received forward image data (S102).

The vehicle-mounted controller 21 of the working vehicle 1 causes the vehicle-mounted communication device 23 to transmit rearward image data, which is data of a rearward captured image 42b captured by the rear camera 25c1, from the working vehicle 1 to the remote control apparatus 30 (S103). Upon receipt of the rearward image data by the communication unit 33 of the remote control apparatus 30, the controller 31 causes the display 34 to display, on the remote monitoring screen 40, the rearward captured image 42b based on the received rearward image data (S104). In so doing, the controller 31 causes the display 34 to display, on the remote monitoring screen 40, the rearward captured image 42b such that the rearward captured image 42b is smaller than the forward captured image 42a.

The vehicle-mounted controller 21 causes the vehicle-mounted communication device 23 to transmit, to the remote control apparatus 30, information relating to the status of the travel system of the working vehicle 1, as the status of the working vehicle 1 (S105). Upon receipt of the information relating to the status of the travel system by the communication unit 33 of the remote control apparatus 30, the controller 31 causes the display 34 to display windows 41a and 41b on the opposite sides of the rearward captured image 42b on the remote monitoring screen 40 (S106). Next, the controller 31 causes the display 34 to display, in the windows 41a and 41b, the received information relating to the status of the travel system of the working vehicle 1 (S107).

Note that the information relating to the status of the travel system of the working vehicle 1 displayed in the windows 41a and 41b is detected by sensors in or on the working vehicle 1. Specifically, for example, the communication unit 33 of the remote control apparatus 30 receives, as the status of the travel system of the working vehicle 1, information such as the direction of travel (forward or rearward) of the working vehicle 1, the speed stage of the sub transmission of the transmission 5 and the ratio of the main transmission of the transmission 5, and the degree of opening of the accelerator pedal. In such a case, the controller 31 causes the display 34 to display, in the window 41a, information relating to the direction of travel of the working vehicle 1, the speed stage of the sub transmission, the ratio of the main transmission, and the degree of opening of the accelerator pedal.

The communication unit 33 also receives, for example, information relating to the number of revolutions of the prime mover 4 and the traveling speed of the working vehicle 1, as the status of the travel system of the working vehicle 1. In such a case, the controller 31 causes the display 34 to display, in the window 41b, information relating to the number of revolutions of the prime mover 4 and the traveling speed.

The controller 31 causes the indication “under remote operation” to be displayed in the window 41b when the remote control apparatus 30 is allowed to operate the working vehicle 1 remotely, i.e., when the working vehicle 1 can be operated based on a remote operation signal from the remote control apparatus 30.

The vehicle-mounted controller 21 of the working vehicle 1 causes the vehicle-mounted communication device 23 to transmit, to the remote control apparatus 30, information relating to the attitude of the working vehicle 1 (vehicle body 3) and the working implement 2 detected by the inertial measurement unit 24b etc., (S108). Upon receipt of the information relating to the attitude of the working vehicle 1 and the working implement 2 by the communication unit 33 of the remote control apparatus 30, the controller 31 causes, based on the received information, information relating to the attitude of the working vehicle 1 and information relating to the attitude of the working implement 2 to be displayed on the forward captured image 42a and the rearward captured image 42b, respectively, in a superimposed manner (S109: attitude displaying step).

The following details the attitude displaying step. Note that the following attitude displaying step is performed by the controller 31 of the remote control apparatus 30 controlling the display 34.

The controller 31 causes a horizontal reference line (horizontal reference object) 55 to be displayed in a superimposed manner on the forward captured image 42a and on the rearward captured image 42b on the remote monitoring screen 40 displayed by the display 34. The horizontal reference line 55 indicates that the working vehicle 1 (vehicle body 3) or the working implement 2 is not tilted in a lateral direction (roll direction), i.e., indicate that the roll angle (angle of inclination to the left/right) θr is 0 degrees. Thus, the controller 31 keeps the horizontal reference line 55 horizontal (not tilted) even if the working vehicle 1 or the working implement 2 is tilted.

The controller 31 causes a roll index line (first index object) indicating the roll angle (angle of inclination to the left/right) Or of the working vehicle 1, a numerical value 52a of the roll angle θr of the working vehicle 1, and a display area 52b for the numerical value 52a to be displayed on the forward captured image 42a and on the rearward captured image 42b. The controller 31 causes the roll index line 51 to be tilted relative to the horizontal reference line 55 based on the roll angle θr detected by the inertial measurement unit 24b, and causes the numerical value of the roll angle θr to be displayed in the display area 52b.

For example, in a case that the working vehicle 1 is titled downward in the rightward direction and the roll angle θr is −15 degrees, the controller 31 causes the roll index line 51 to rotate clockwise such that the right end of the roll index line 51 is lower than the left end of the roll index line 51 on the screen. In a case that the working vehicle 1 is tilted downward in the leftward direction and the roll angle θr is +15 degrees, the controller 31 causes the roll index line 51 to rotate counterclockwise such that the left end of the roll index line 51 is lower than the right end of the roll index line 51 on the screen. Note that, in the present example embodiment, the controller 31 causes the roll index line 51 to rotate about the display area 52b for the numerical value 52a.

The controller 31 causes scale lines (scale objects) 53a, numerical values 53b, and a pitch index line (second index object) 54 to be displayed on the forward captured image 42a. The pitch index line 54 shows the inclination of the working vehicle 1 in the pitch direction (front-rear direction) using markings. The scale lines 53a displayed by the controller 31 are the markings of the angles of inclination of ±10 degrees, ±20 degrees, and ±30 degrees of the working vehicle 1 in the pitch direction, for example.

The controller 31 causes the pitch index line 54 to move upward or downward on the screen based on the pitch angle θp detected by the inertial measurement unit 24b. For example, in a case that the working vehicle 1 is tilted downward in the forward direction and the pitch angle θp is −7 degrees, the controller 31 causes the pitch index line 54 to move downward from the roll index line 51 based on the pitch angle θp. In a case that the working vehicle 1 is tilted upward in the forward direction and the pitch angle θp is +7 degrees, the controller 31 causes the pitch index line 54 to move upward from the roll index line 51 based on the pitch angle θp.

Note that the controller 31 causes the scale lines 53a, the numerical values 53b, and the pitch index line 54 to also rotate clockwise or counterclockwise based on the roll angle θr similarly to the roll index line 51.

The controller 31 causes a work attitude line (second attitude object) 56 indicating the attitude of the working implement 2 to be displayed in a superimposed manner on the rearward captured image 42b. Specifically, when the attitude of the working implement 2 is changed by, for example, the angle change cylinder 8f of the coupling device 8, the vehicle-mounted controller 21 detects the roll angle of the working implement 2 as the changed attitude of the working implement 2 relative to the lateral direction, and causes the vehicle-mounted communication device 23 to transmit information relating to the roll angle to the remote control apparatus 30. Upon receipt of the information relating to the roll angle of the working implement 2 by the communication unit 33, the controller 31 of the remote control apparatus 30 causes the work attitude line 56 indicating the roll angle to be displayed in a superimposed manner on the rearward captured image 42b. The controller 31 causes the work attitude line 56 to rotate clockwise or counterclockwise relative to the horizontal reference line 55 based on the changed roll angle of the working implement 2.

The working vehicle remote operation assistance system 100 and the remote control apparatus 30 according to the present example embodiment have the following configuration and produce the following effects.

The working vehicle remote operation assistance system 100 according to the present example embodiment includes a detector 24 (the inertial measurement unit 24b) to detect attitude of a working vehicle 1, a first imager (the rear camera) 25c1 to perform imaging of a surrounding area toward a working implement 2 coupled to the working vehicle 1 (a surrounding area around the working vehicle 1), a second imager (the internal camera) 25c2 to perform imaging of a surrounding area around the working vehicle 1 that is different from that of the first imager 25c1, and a remote control apparatus 30 including a display 34 and a controller 31, the display 34 being configured to display a plurality of captured images 42b, 42a obtained by the first imager 25c1 and the second imager 25c2, the controller 31 being configured or programmed to control the display 34 and command that a first attitude object 51 to 55 indicating the attitude of the working vehicle 1 detected by the detector 24, 24b be displayed in a superimposed manner on the plurality of captured images 42a, 42b displayed on the display 34.

With the above configuration, the operator is able to understand the attitude of the working vehicle 1 easily by looking at the captured image 42b of a surrounding area of the working vehicle 1 imaged toward the working implement 2 and displayed on the display 34 of the remote control apparatus 30, the captured image 42a different from said working implement-side captured image, and the first attitude object 51 to 55 displayed in a superimposed manner on the captured images 42a, 42b. Moreover, for example, when the operator causes the working implement 2 to perform work while causing the working vehicle 1 to travel by remote operation, the operator is able to know what is there, or what is going on, in a coupling direction at which the working implement 2 is coupled to the working vehicle 1 and in a direction different from the coupling direction while easily associating it with the attitude of the working vehicle 1 in each of said coupling direction and said different direction, resulting in improved remote control of the working vehicle 1 notably by ensuring that the user can focus on the current display while getting the attitude information in the current direction. The proposed configuration enables to ensure that the user can remain focused on a single portion of the display while getting the required information.

In the present example embodiment, the first imager 25c1 performs imaging in a direction at which the working implement 2 is coupled to the working vehicle 1, the second imager 25c2 performs imaging in a direction in which the working vehicle 1 travels, and the controller 31 causes the display 34 to display a first captured image 42b obtained by the first imager 25c1 and a second captured image 42a obtained by the second imager 25c2 and to superimpose the first attitude object 51 to 55 on the displayed first captured image 42b and the displayed second captured image 42a. This enables the operator to, for example, know what is there, or what is going on, in the traveling direction of the working vehicle 1 and in the coupling direction at which the working implement 2 is coupled while easily associating it with the attitude of the working vehicle 1 in each of the traveling direction of the working vehicle 1 and the coupling direction at which the working implement 2 is coupled when the operator causes the working implement 2 to perform work while causing the working vehicle 1 to travel by remote operation, resulting in easier remote operation of the working vehicle 1.

In the present example embodiment, the first imager 25c1 performs imaging of a rear area behind the working vehicle 1 where the working implement 2 is coupled thereto, the second imager 25c2 performs imaging of a front area in front of the working vehicle 1, and the controller 31 causes the display 34 to display a rearward captured image 42b of the vehicle body 3 obtained by the first imager and a forward captured image 42a of the vehicle body 3 obtained by the second imager and to superimpose the first attitude object 51 to 55 on the displayed rearward captured image 42b and the displayed forward captured image 42a. This enables the operator to understand the attitude of the working vehicle 1 easily by looking at the forward captured image 42a and the rearward captured image 42b of the working vehicle 1 displayed on the display 34 and the first attitude object 51 to 55 superimposed on the captured images 42a, 42b. Moreover, when the operator causes the working vehicle 1 to travel forward or rearward by remote operation, or when the operator causes the working implement 2 coupled to and behind the working vehicle 1 to perform work by remote operation, though not limited to these cases, the operator is able to know what is there, or what is going on, in front of and behind the working vehicle 1 while easily associating it with the attitude of the working vehicle 1, resulting in easier remote operation of the working vehicle 1.

In the present example embodiment, the controller 31 commands that the first attitude object 51 to 55 be displayed in a superimposed manner at center regions of the plurality of captured images 42a, 42b. This enables the operator to understand the attitude of the working vehicle 1 easily by taking a glance at each of the plurality of captured images 42a, 42b. Moreover, this makes it possible to reduce the burden on the operator by reducing an amount of movement in the line of sight of the operator.

In the present example embodiment, the controller 31 commands that the first attitude object 51 to 55 be displayed such that a captured subject visually contained in each of the plurality of captured images 42a, 42b at a display position of the first attitude object 51 to 55 is viewable. This enables the operator to understand the attitude of the working vehicle 1 easily while viewing the captured subject visually contained in each of the plurality of captured images 42a, 42b.

In the present example embodiment, the controller 31 commands that a horizontal reference object (horizontal reference line) 55 corresponding to a horizontal attitude of the working vehicle 1 and an index object (first index object, roll index line) 51 indicating an angle of inclination (first angle of inclination) Or of the working vehicle 1, detected by the detector 24, 24b, be displayed in a superimposed manner, as the first attitude object, on at least any one of the plurality of captured images 42a, 42b, and commands that the index object 51 be inclined with respect to the horizontal reference object 55 in accordance with the angle of inclination Or of the working vehicle 1. This enables the operator to understand easily in which direction and how much the working vehicle 1 is inclined with respect to a horizontal state.

In the present example embodiment, the controller 31 commands that a numerical value 52a of the angle of inclination Or of the working vehicle 1 be displayed in a superimposed manner, as the first attitude object together with the horizontal reference object 55 and the index object 51, on at least any one of the plurality of captured images 42a, 42b. This enables the operator to understand easily and numerically in which direction and how much the working vehicle 1 is inclined with respect to a horizontal state.

In the present example embodiment, the controller 31 commands that a scale object 53a, 53b for reading an angle of inclination (second angle of inclination) Op of the working vehicle 1 in a predetermined direction (front-rear direction) and an index object (second index object, pitch index line) 54 indicating the angle of inclination Op of the working vehicle 1 in the predetermined direction, detected by the detector 24, 24b, in relation to the scale object 53a, 53b be displayed in a superimposed manner, as the first attitude object, on at least any one of the plurality of captured images 42a, 42b. This enables the operator to understand easily and numerically how much the working vehicle 1 is inclined in the predetermined direction (front-rear direction).

In the present example embodiment, the controller 31 commands that the scale object 53a, 53b and the index object 54 be inclined in accordance with an angle of inclination Or of the working vehicle 1 in a direction (horizontal direction) different from the predetermined direction (front-rear direction), detected by the detector 24, 24b. This enables the operator to understand easily and numerically how much the working vehicle 1 is inclined in the predetermined direction (front-rear direction), and, in addition, enables the operator to understand easily how much the working vehicle 1 is inclined in the direction (horizontal direction) different from the predetermined direction.

In the present example embodiment, the controller 31 commands that a plurality of scale lines 53a and a plurality of numerical values 53b corresponding to the plurality of scale lines 53a respectively be displayed as the scale object 53a, 53b, and commands that the plurality of scale lines 53a and the plurality of numerical values 53b be displayed such that a captured subject visually contained in at least any one of the plurality of captured images 42a, 42b at a display position of the scale object 53a, 53b is viewable. This enables the operator to understand easily in which direction and how much the working vehicle 1 is inclined while viewing the captured subject visually contained in at least any one of the plurality of captured images 42a, 42b.

In the present example embodiment, the controller 31 commands that the first attitude object 51 to 55 indicating either one or both of a pitch angle θp and a roll angle θr of the working vehicle 1 detected by the detector 24, 24b be displayed in a superimposed manner on the plurality of captured images 42a, 42b. This enables the operator to know either one or both of the pitch angle θp and the roll angle θr of the working vehicle 1 easily by looking at the plurality of captured images 42a, 42b and the first attitude object 51 to 55. Moreover, it becomes easier for the operator to operate the working vehicle 1 remotely via the remote control apparatus 30 based on the pitch angle θp and the roll angle θr of the working vehicle 1.

In the present example embodiment, the controller 31 commands that a second attitude object (work attitude line) 56 indicating an attitude of the working implement 2 be displayed in a superimposed manner on, among the plurality of captured images 42a, 42b, a captured image 42b visually containing the working implement 2. This enables the operator to understand the attitude of the working implement 2 easily by looking at the captured image 42b and the second attitude object 56. Moreover, it becomes easier for the operator to perform work via the working implement 2 by operating the working vehicle 1 remotely via the remote control apparatus 30 based on the attitude of the working implement 2.

In the present example embodiment, the controller 31 commands that the second attitude object 56 indicating the attitude of the working implement 2 after a change in a case where the attitude of the working implement 2 has been changed by an attitude changer (coupling device) 8 provided on the working vehicle 1 be displayed in a superimposed manner on the captured image 42b visually containing the working implement 2. This enables the operator to understand the attitude of the working implement 2 having been changed by the attitude changer 8 easily by looking at the captured image 42b and the second attitude object 56. Moreover, the operator is able to know a state of a work trace left by the working implement 2 while causing the working vehicle 1 to travel by remote operation via the remote control apparatus 30 based on the attitude of the working implement 2 after the change.

In the present example embodiment, the controller 31 commands that the first attitude object 51 to 55 and the second attitude object 56 be displayed in a superimposed manner on a portion of the working vehicle 1 or the working implement 2 visually contained in the plurality of captured images 42a, 42b. This makes the first attitude object 51 to 55 and the second attitude object 56 easier to view while preventing the first attitude object 51 to 55 and the second attitude object 56 from being obstructive to seeing what is there, or what is going on, in the first direction and the second direction with respect to the working vehicle 1 visually contained in the plurality of captured images 42a, 42b.

Although the present invention has been described above, it shall be construed that the example embodiments disclosed herein are just illustrative in every respect and not restrictive. The scope of the present invention is defined not by the foregoing description but by the appended claims, and all modifications made within the scope of the claims and its equivalents are intended to be encompassed herein.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle remote operation assistance system, comprising:
a detector to detect an attitude of a working vehicle;
a first imager to perform imaging of a surrounding area around a working implement coupled to the working vehicle;
a second imager to perform imaging of a surrounding area around the working vehicle, different from the surrounding area around the working implement imaging of which the first imager is configured to perform; and
a remote control apparatus including:
a display to display a plurality of captured images obtained by the first imager and the second imager; and
a controller configured or programmed to control the display and command that a first attitude object indicating the attitude of the working vehicle detected by the detector be displayed in a superimposed manner on the plurality of captured images displayed on the display.

2. The working vehicle remote operation assistance system according to claim 1, wherein:
the first imager is configured to perform imaging in a direction from the working vehicle to the working implement coupled to the working vehicle;
the second imager is configured to perform imaging in a direction toward which the working vehicle travels; and
the controller is configured or programmed to cause the display to display a first captured image obtained by the first imager and a second captured image obtained by the second imager and to superimpose the first attitude object on the displayed first captured image and the displayed second captured image.

3. The working vehicle remote operation assistance system according to claim 1, wherein:
the first imager is configured to perform imaging of a rear area behind the working vehicle where there is the working implement coupled thereto;
the second imager is configured to perform imaging of a front area in front of the working vehicle; and
the controller is configured or programmed to cause the display to display a rearward captured image of the working vehicle obtained by the first imager and a forward captured image of the working vehicle obtained by the second imager and to superimpose the first attitude object on the displayed rearward captured image and the displayed forward captured image.

4. The working vehicle remote operation assistance system according to claim 1, wherein the controller is configured or programmed to command that the first attitude object be displayed in a superimposed manner at center regions of the plurality of captured images.

5. The working vehicle remote operation assistance system according to claim 1, wherein the controller is configured or programmed to command that the first attitude object be displayed such that a captured subject visually contained in each of the plurality of captured images at a display position of the first attitude object is viewable.

6. The working vehicle remote operation assistance system according to claim 1, wherein the controller is configured or programmed to:
command that a horizontal reference object corresponding to a horizontal attitude of the working vehicle and an index object indicating an angle of inclination of the working vehicle, detected by the detector, be displayed in a superimposed manner, as the first attitude object, on at least any one of the plurality of captured images; and
command that the index object be inclined with respect to the horizontal reference object in accordance with the angle of inclination of the working vehicle.

7. The working vehicle remote operation assistance system according to claim 6, wherein the controller is configured or programmed to command that a numerical value of the angle of inclination of the working vehicle be displayed in a superimposed manner, as the first attitude object together with the horizontal reference object and the index object, on at least any one of the plurality of captured images.

8. The working vehicle remote operation assistance system according to claim 1, wherein the controller is configured or programmed to command that a scale object for reading an angle of inclination of the working vehicle in a predetermined direction and an index object indicating the angle of inclination of the working vehicle in the predetermined direction, detected by the detector, in relation to the scale object be displayed in a superimposed manner, as the first attitude object, on at least any one of the plurality of captured images.

9. The working vehicle remote operation assistance system according to claim 8, wherein the controller is configured or programmed to command that the scale object and the index object be inclined in accordance with an angle of inclination of the working vehicle in a direction different from the predetermined direction, detected by the detector.

10. The working vehicle remote operation assistance system according to claim 8, wherein the controller is configured or programmed to:
command that a plurality of scale lines and a plurality of numerical values corresponding to the plurality of scale lines respectively be displayed as the scale object; and
command that the plurality of scale lines and the plurality of numerical values be displayed such that a captured subject visually contained in at least any one of the plurality of captured images at a display position of the scale object is viewable.

11. The working vehicle remote operation assistance system according to claim 1, wherein the controller is configured or programmed to command that the first attitude object indicating either one or both of a pitch angle and a roll angle of the working vehicle detected by the detector be displayed in a superimposed manner on the plurality of captured images.

12. The working vehicle remote operation assistance system according to claim 1, wherein the controller is configured or programmed to command that a second attitude object indicating an attitude of the working implement be displayed in a superimposed manner on, among the plurality of captured images, a captured image visually containing the working implement.

13. The working vehicle remote operation assistance system according to claim 12, wherein the controller is configured or programmed to command that the second attitude object indicating the attitude of the working implement after a change, in a case where the attitude of the working implement has been changed by an attitude changer provided on the working vehicle, be displayed in a superimposed manner on the captured image visually containing the working implement.

14. The working vehicle remote operation assistance system according to claim 12, wherein the controller is configured or programmed to command that the first attitude object and the second attitude object be displayed in a superimposed manner on a portion of the working vehicle or the working implement visually contained in the plurality of captured images.

15. A remote control apparatus provided in the working vehicle remote operation assistance system according to claim 1.
